(19) United States
(12) Patent Application Publication
(10) Pub. No.: US 2013/0312586 A1
(43) Pub. Date: Nov. 28, 2013

(54) PROTECTIVE COVER AND CLEANING SYSTEM FOR MUSICAL INSTRUMENTS

(71) Applicant: Robert D. Brunnemer, Arvada, CO (US)

(72) Inventor: Robert D. Brunnemer, Arvada, CO (US)

(21) Appl. No.: 13/845,994

(22) Filed: Mar. 18, 2013

Related U.S. Application Data
(60) Provisional application No. 61/611,680, filed on Mar. 16, 2012.

(51) Int. Cl. G10D 3/00

(52) U.S. Cl. CPC G10D 3/00
USPC 84/453

(57) ABSTRACT

A system herein provides a protective cover that also serves as a cleaning product for multiple musical instruments such as guitars. The system is designed to protect instruments from dust, oils and/or other debris (e.g., resulting from being played) that attach to the instrument and influence the oxidization process. For example, oxidation tends to reduce the life of strings of stringed instruments. The system is designed to remove oil and debris through user cleaning while protecting the instrument when covered and not being used.

### CROSS REFERENCE TO RELATED APPLICATIONS

This patent application claims priority to, and thus the benefit of an earlier filing date from, U.S. Provisional Patent Application No. 61/611,680 (filed Mar, 16, 2012), the entire contents of which are hereby incorporated by reference.

### FIELD OF THE INVENTION

The field of the invention relates generally to the cleaning and maintenance of musical instruments.

### BACKGROUND

Musical instruments accumulate debris and contaminants with use. For example, a human using an instrument deposits oils, dirt, and/or other debris during use of the instrument and through their simple exposure to air. This debris oxidizes and otherwise damages portions of the instrument. Some products focus on protecting an instrument as a whole (e.g., with a case enclosing the entire instrument) to provide protection against percussive damage. But these cases do not provide any form of cleaning

### SUMMARY

A system herein provides a protective cover that also serves as a cleaning product for multiple musical instruments including stringed instruments. The system is designed to protect instruments from dust, dirt, oils, and/or other debris (e.g., resulting from being played) that attach to the instrument and influences the oxidization process. For example, oxidation tends to reduce the life of strings on a stringed instrument. The system is designed to remove oil and debris through user cleaning while also cleaning/protecting the instrument when it is not being used.

In one embodiment, a stringed instrument protection system includes a material operable to cover at least the strings of a stringed instrument. The material has a softness and flexibility to clean the strings of the stringed instrument when removed from the stringed instrument and rubbed against the strings. The stringed instrument protection system also includes at least one fastener operable to snugly secure the material to the strings of the stringed instrument to absorb debris when covering the strings. The fastener may include a sleeve configured from the material with one end closed, the sleeve being operable to slip over tuning pegs of the stringed instrument to secure the material to the stringed instrument. The stringed instrument protection system may include a pocket configured with the material for retaining additional strings for the stringed instrument. The at least one fastener may include a zipper operable to secure the material about the entirety of the stringed instrument.

### BRIEF DESCRIPTION OF THE DRAWINGS

Some embodiments of the present invention are now described, by way of example only, and with reference to the accompanying drawings. The same reference number represents the same element or the same type of element on all drawings.

FIG. 1 is a schematic of a stringed instrument protection system in one exemplary embodiment of the invention.

FIG. 2 is front view of the stringed instrument protection system secured to a guitar in one exemplary embodiment of the invention.

FIG. 3 is a rear view of the stringed instrument protection system secured to a guitar in one exemplary embodiment of the invention.

FIG. 4 is a front view of another stringed instrument protection system secured to a guitar in one exemplary embodiment of the invention.

### DETAILED DESCRIPTION OF THE DRAWINGS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention and are to be construed as being without limitation to such specifically recited examples and conditions. As a result, the invention is not limited to the specific embodiments or examples described below.

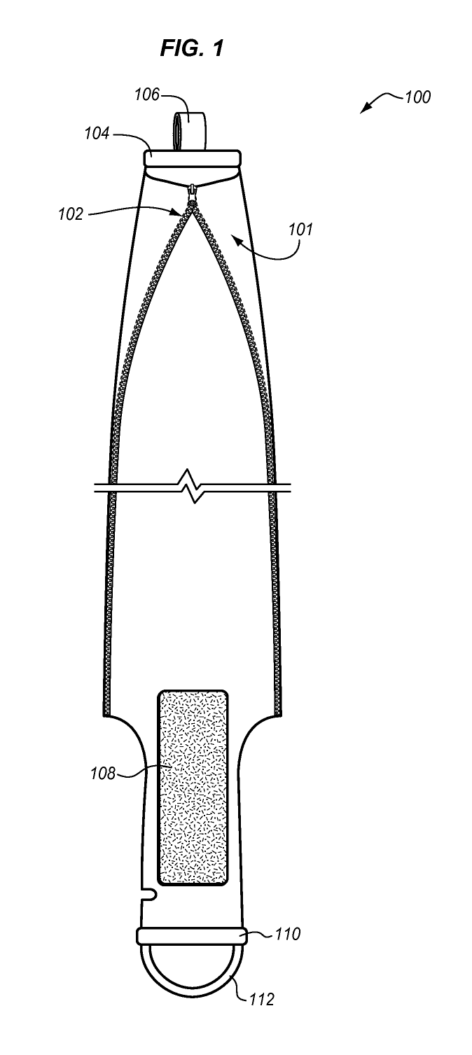

FIG. 1 is a schematic of a stringed instrument protection system 100 removed from an instrument in one exemplary embodiment. The majority the system 100 generally regards a material 101 that fits snugly over the surface of the instrument. The system 100 includes a tab 106 at the top for gripping when attempting to close a zipper 102 of the system 100 around a stringed musical instrument. A boning material 104 may be used to help to secure the system 100 when closing the zipper 102. Further the boning material 110 and an elastic strap 112 may be used to help secure the system 100 around a surface of the instrument (e.g., via a strap hook of a stringed musical instrument, such as the strap hook 202 below). For example, the reinforced nature of the system 100 via the boning material 104 may allow the zipper 102 to move more easily. The system 100 may also comprise a pad of additional material 108 for further absorption and protection around the playing area of the strings of a stringed musical instrument. In one exemplary embodiment, the pad of additional material 108 is a felt material and/or a cotton blend to provide enhanced protection and improved cleaning capability.

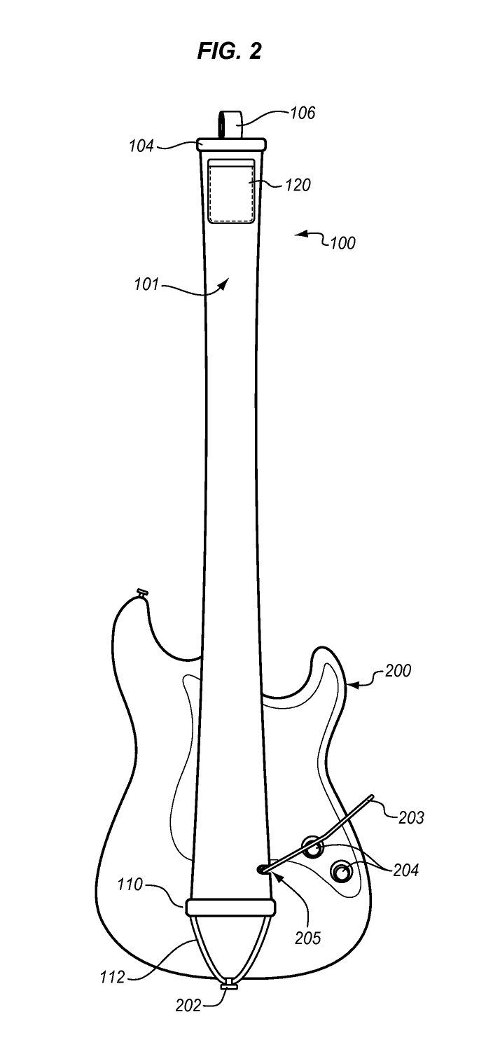

FIG. 2 shows a front side view of an exemplary the system 100 as applied to a stringed musical instrument 200 (e.g., a guitar via the strap hook 202). The elastic strap 112 is stretched to retain the system 100 on the stringed instrument 200 by engaging the strap hook 202 of the stringed instrument 200. It may be noted that appropriate notches or holes 205 may be cut in the system 100 to accommodate jacks for plugging an electric musical instrument into an amplifier or other processing devices as well as holes or slots for accessories (such as a guitar “whammy bar” 203) and knobs 204. The system 100 is stretched taut over the strings (not shown) of the stringed instrument so as to remain in contact with the strings when the stringed instrument 200 is not use. This allows the system 100 to continually clean the strings of the stringed instrument 200, for example, through the passive vibration of the strings while substantially preventing airborne contaminants from contacting the strings.

In one embodiment, the system 100 is configured with a pocket 120 that is operable to retain small items such as extra strings and/or picks for the stringed instrument 200. The pocket 120 may be configured of the same material as the material 101. Alternatively, the material may be configured of a material that makes printing more easily performed. For example, a band may wish to advertise their name or logo on the stringed instrument 200. The pocket 120 may be configured of a material that allows for relatively easy printing of the name/logo. The pocket 120 may be affixed to the surface of the system 100.

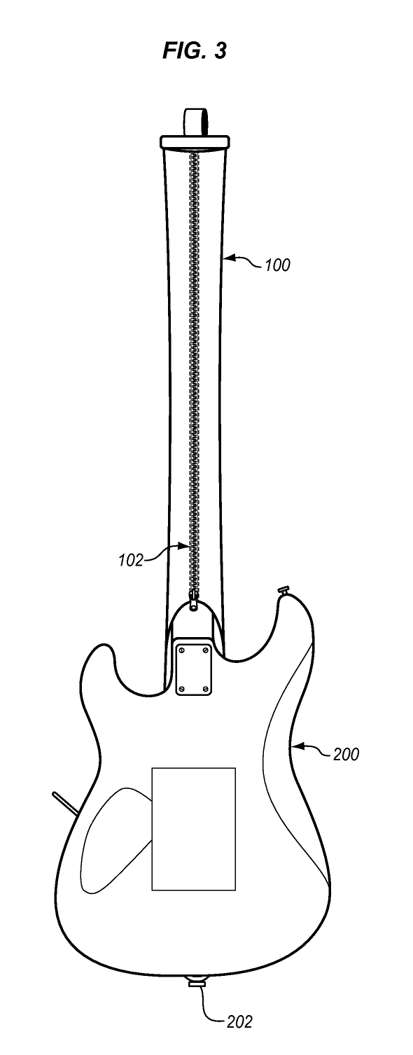

FIG. 3 shows a back side view of an exemplary the system 100 applied to the stringed instrument 200 with a zipper 102 that closes to protect guitar 200 from debris. As can be seen in all figures, the system 100 may be used in combination with other cases in that it does not interfere with typical hard or soft cases for a stringed instrument or for any other musical instrument that may utilize the system 100.

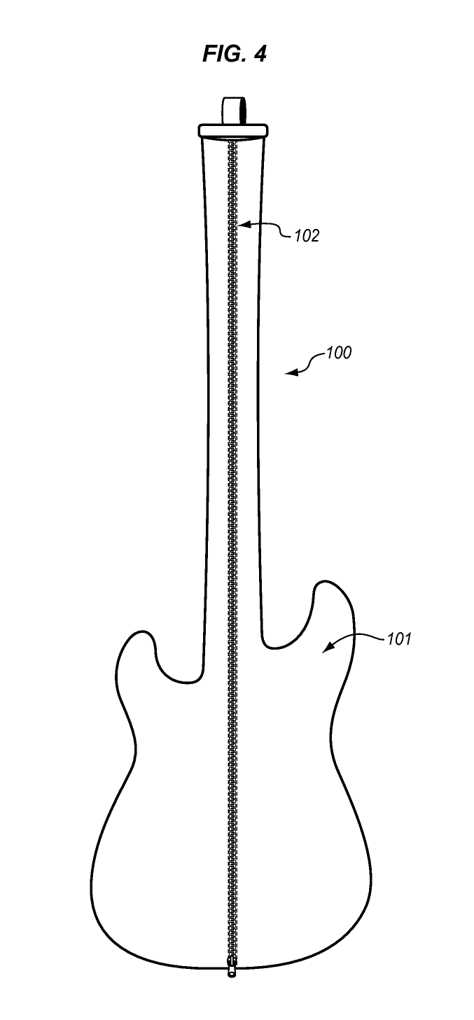

FIG. 4 is a front view of another stringed instrument protection system secured to a guitar in one exemplary embodiment of the invention. In this embodiment, the system 100 wraps around entirety of the stringed instrument 200. Again, the zipper 102 may be placed on the backside of the stringed instrument so as to not interfere with the contact of the material 101 with the strings.

One preferred material for the system 100 is a combination of cotton and felt (i.e., a woolen material). This material provides a desired flexibility, penetrative cleaning, and protective ability. When utilizing the system 100 after each session of play, the longevity or life of the strings is noticeably increased due at least in part to the passive cleaning of the stings when the system is affixed to the instrument. The system is also operable to be used in cleaning the instrument after removal acting as a sort of cleaning cloth for the instrument that can be rubbed against the instrument to clean it.

Generally, the system absorbs moisture, oils, debris and the like by covering the strings keeping them dry and free from airborne contaminants. As indicated in the attached diagrams, the system 100 fits snugly over and around the instrument's headstock, neck fret board, pickups, and bridge plate. In one exemplary embodiment, elastic and boning material is used at bridge plate for a tight secure fit around strap knob at the base of the guitar. In one embodiment, the zipper 102 is a plastic zipper along the backside of neck fret board of a guitar so as to avoid scratching and/or other damage. A tag at top of the system offers proper leverage for zipper application.

Snaps, buttons, hooks, clips, hook and loop, interlocking stripping, islets, or metal zippers are other ways that may be used to fasten the system 100 to a stringed instrument 200. Other materials such as muslin or hemp may be considered for enhanced durability. In addition, a heavier portion of the material may be added (such as over the playing area of a stringed instrument) for further protection and for better cleaning properties. In some embodiments, the additional material may be a different material to provide the enhanced protection and cleaning For example, in one exemplary embodiment, a heavier felt material may be added as a pad for added protection and improved cleaning capability for guitar or other stringed instruments. The material may be configured in such a way as to make it easily cleanable (e.g., machine washable) to remove accumulated debris, oils, etc. accumulating on the material 101.

The system differs from other products available in the market today in several ways. One, the system provides dual purpose cover and cleaner. The system, in one embodiment, by specifically protecting the strings of an instrument, their usable life span is increased. Other products focus on the stringed instrument as a whole (e.g., a case enclosing the entire instrument) but do not provide a cleaning feature and therefore are less effective than the system in protecting the stringed part of a stringed musical instrument. The system can be used in conjunction with another case (both hard and soft), as well as a stand. This allows the system 100 to not interfere with the current method of transportation or overall protection for the stringed instrument. Instead offers greater protection to the parts of the stringed instrument 200 that are essential for the instrument to work properly.

The design in the shape of the system 200 is generally a matter of design choice and configured to match the particular shape of the instrument being protected. In this regard, the invention is not intended to be limited to any particular type of instruments. Rather, the system 200 may be operable to snugly fit against other types of instruments, including horn instruments, so as to prevent airborne debris from accumulating on the instrument as well as removing accumulated debris when the instrument is not in use.

What is claimed is:

1. A stringed instrument protection system, comprising:
a material operable to cover at least strings of a stringed instrument, wherein the material has a softness and flexibility to clean the strings of the stringed instrument when removed from the stringed instrument and rubbed against the strings; and
at least one fastener operable to tightly secure the material to the strings of the stringed instrument to absorb debris when covering the strings of the stringed instrument.

2. The stringed instrument protection system of claim 1, wherein:
the at least one fastener includes a sleeve configured from the material with one end closed, the sleeve being operable to slip over tuning pegs of the stringed instrument to secure the material to the stringed instrument.

3. The stringed instrument protection system of claim 1, further comprising:
a pocket configured with the material for retaining additional strings for the stringed instrument.

4. The stringed instrument protection system of claim 1, wherein:
the at least one fastener includes a zipper operable to secure the material about the entirety of the stringed instrument.
